(19) United States
(12) Patent Application Publication
(10) Pub. No.: US 2013/0101488 A1
(43) Pub. Date: Apr. 25, 2013

(54) OPTIMIZED BORON POWDER FOR NEUTRON DETECTION APPLICATIONS

(71) Applicant: James Michael Lustig, Mantua, OH (US)

(72) Inventor: James Michael Lustig, Mantua, OH (US)

(73) Assignee: General Electric Company, Schenectady, NY (US)

(21) Appl. No.: 13/276,376

(22) Filed: Oct. 19, 2011

(51) Int. Cl. C01B 35/02

(52) U.S. Cl. 423/298

(57) ABSTRACT

An optimized boron powder is provided. The quantity of a soluble residue comingled with the optimized boron powder is less than 7.00×10⁻⁴ grams of soluble residue per gram of boron. In further examples, the optimized boron powder includes crystalline boron particles created by jet milling a boron feed stock. The boron powder includes more than about 75% of the particles having a diameter less than about 1 micron, more than about 95% of the particles having a diameter less than about 3 microns, and essentially all of the particles having a diameter less than about 15 microns.

### BACKGROUND OF THE INVENTION

1. Field of the Invention

The invention relates to boron powder, and specifically relates to boron powders used in coatings for neutron detectors.

2. Discussion of Prior Art

Boron powder is used as a primary component of boron coatings in numerous applications. Such applications include, but are not limited to boron coatings used for neutron detection, abrasion protection for die-casting dies, improved wear resistance for biomedical implants, etc. Some of these applications are adversely affected by organic contaminants within the boron powder, as the contaminants can produce downstream defects in boron coating applications.

A contaminated boron powder can include organic contaminants from various sources. For example, jet milled boron powder has been found to be susceptible to contamination from the air supply used in the milling process. Specifically, boron powder contaminants may include lubrication oil from an air compressor when compressed air is used to operate a jet mill. This contamination can result in coating defects such as non-uniform coatings and gas contamination resulting in degraded neutron detector effectiveness. Other example contaminants are polymeric liner material from the jet mill and adhesive materials used to attach the polymeric liner material to a jet mill interior wall.

Other attributes of boron powders are desirable to help ensure boron coatings exhibit certain intended characteristics. Some applications of boron powder require relatively thin coatings. For example, boron coatings on neutron detectors are necessarily applied in a thin layer to help charged particles emanate from the boron coating following neutron collisions with the boron coating. Reduction of boron particle size can help enable thinner layers of boron coatings. Additionally, boron powder may include traces of other elements and compounds which reduce the effectiveness of a boron coating. For example, significant amounts of certain elements in a boron coating may interact with gamma radiation, creating a false signal in a neutron detector. Furthermore, the ratio of powder from particular boron isotopes to the total boron powder content plays a role in the effectiveness of neutron detectors.

Boron powder is a relatively expensive material which, in turn, makes both contaminated boron powder and downstream affected goods costly missteps in the manufacturing process. Some previous methods of recovering contaminated boron powder include rinsing the powder with hexane, methylene chloride, and ethylene glycol, each in combination with filters and/or centrifuges. Therefore, there is a need for an optimized boron powder.

### BRIEF DESCRIPTION OF THE INVENTION

The following summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

One aspect of the invention provides a boron powder, wherein the quantity of a soluble residue comingled with the boron powder is less than 7.00×10⁻⁴ grams of soluble residue per gram of boron.

### BRIEF DESCRIPTION OF THE DRAWINGS

The foregoing and other aspects of the invention will become apparent to those skilled in the art to which the invention relates upon reading the following description with reference to the accompanying drawings, in which:

FIG. 1 is a scanning electron microscope (SEM) photograph showing an example optimized boron powder for neutron detection applications magnified 5,000 times;

FIG. 2 is an SEM photograph showing the example optimized boron powder for neutron detection applications of FIG. 1 magnified 10,000 times;

FIG. 3 is an SEM photograph showing the example optimized boron powder for neutron detection applications of FIG. 1 magnified 25,000 times; and

FIG. 4 is a schematic illustration, partially torn away, of an example neutron detector using the example optimized boron powder for neutron detection applications of FIG. 1.

### DETAILED DESCRIPTION OF THE INVENTION

Example embodiments that incorporate one or more aspects of the invention are described and illustrated in the drawings. These illustrated examples are not intended to be a limitation on the invention. For example, one or more aspects of the invention can be utilized in other embodiments and even other types of devices. Moreover, certain terminology is used herein for convenience only and is not to be taken as a limitation on the invention. Still further, in the drawings, the same reference numerals are employed for designating the same elements.

In one example of an optimized boron powder for neutron detection applications, soluble residue comingled with the boron powder is less than 7.00×10⁻⁴ grams of soluble residue per gram of boron. One example of a soluble residue is an organic contaminant. It is to be appreciated that the term organic is a broad and expansive classification. In one part, the classification includes materials that contain a carbon component. The organic contaminants can be introduced to the boron powder during a jet milling operation from sources such as air compressor oils, particles of a polymeric liner material used on the interior of a jet mill, and adhesive materials used to adhere polymeric liner material to the interior wall of a jet mill.

Neutron detectors can include a deposition layer of boron powder over a surface of a component that is able to carry a charge. One example of a deposition process is a water-based application of the boron powder to the neutron detector surface. Optimal neutron detector performance depends in part upon an even application of the boron powder with the entire surface properly wetted. Soluble residues such as organic contaminants can adversely affect the application of the water-based application of the boron powder by reducing the hydrophilic nature of the water-based boron powder and creating areas of non-wetted neutron detector surface. These areas of non-wetted neutron detector surface decrease the effective performance of the neutron detector. Thus, it is particularly desirable to have an optimized boron powder for neutron detection applications.

Optimal neutron detector performance also depends in part upon minimal levels of soluble residues in the boron powder applied to the neutron detector surface. Soluble residues such as organic contaminants can outgas, introducing organic compounds to an interior volume of the neutron detector. During the manufacturing process, the interior volume is filled with a specific formulation of gases for effective operation of the neutron detector. The organic compounds resulting from outgassing can foul this specific formulation of gases and reduce the effective operation of the neutron detector. Thus, it is particularly desirable to have an optimized boron powder for neutron detection applications.

An optimized boron powder for neutron detection applications comingled with less than 7.00×10⁻⁴ grams of soluble residue per gram of boron can be obtained by applying gas purity requirements to a gas used to operate a jet mill. Jet mills can be operated by compressed air supplied by a typical air compressor. Soluble residue may be introduced to the boron powder in the form of lubrication oil entrained in the compressed air from a typical air compressor. One example of applying gas purity requirements to the gas used to operate a jet mill is to select an industrially purified gas such as nitrogen. The industrial purification process for nitrogen eliminates a large percentage of the impurities in the gas. When used as a replacement for compressed air at an industrial location, nitrogen does not impart a significant amount of soluble residue to the boron powder. Other examples include noble gases (such as argon) or steam which are considered chemically inert to the boron and do not add a significant amount of soluble residue to the boron powder.

Another example of applying gas purity requirements to the gas used to operate a jet mill is to apply air filtration to the supply of compressed air. One example of air filtration to reduce the amount of soluble residue imparted to the boron powder is the application of ISO 8573.1: 2001 Class 1.2.1 requirements to the air supply. This standard limits the amount of entrained oil in the air supply to a maximum of 0.01 milligrams of oil per cubic meter of air, which does not significantly affect the hydrophilic nature of the boron powder. Filtration devices can be utilized to meet this standard and the devices can include sub-micron filters and can further include adsorption filters to remove oil vapors from the compressed air supply.

The optimized boron powder for neutron detection applications can also be obtained by jet milling boron particles in a jet mill that includes non-contaminating liner materials within the jet mill. Jet mills can mill feed stock particles to a particular profile of diameters by creating high-speed collisions between individual feed stock particles and between feed stock particles and the jet mill interior walls. The high-speed collisions can erode portions of the jet mill interior walls, particularly if the feed stock possesses abrasive qualities. In order to alleviate that issue, consumable liner material can be secured to the jet mill interior walls. However, one common consumable liner material is polyurethane, which is not an acceptable liner material choice for the production of the optimized boron powder. The high-speed collisions between the particles and the polyurethane liner erode particles of polyurethane which then contaminate the boron powder as a soluble residue.

As an alternative to a polyurethane material, the jet mill liners can be constructed of the same material as the feed stock, or a similar chemical compound that will not impart soluble residue to the feed stock. For example, when jet milling boron feed stock, liner material composed of boron or boron carbide would erode to impart boron or boron carbide to the boron powder rather than a soluble residue. Another alternative to a polyurethane material, the jet mill liners can be constructed of a material that exhibits greater hardness than the feed stock. For example, liner material composed of tungsten carbide is harder than boron, and collisions between the boron particles and the tungsten carbide material are less likely to erode the tungsten carbide and impart contaminants to the boron powder.

Another reduction in soluble residue in the optimized boron powder can be realized by the elimination of adhesives utilized to fasten liner material within the jet mill. The adhesives can be composed of organic material, and significant erosion of the liner material will expose the adhesive to the boron feed stock collisions. After the adhesive is exposed, the boron feed stock collisions will erode the adhesive which can be imparted to the boron powder as a soluble residue. Liner material composed of boron, boron carbide, or tungsten carbide can provide an opportunity to eliminate the organic-based adhesives, and thus eliminate one potential source of soluble residue comingling with the boron powder.

One example method of testing the quantity of soluble residue comingled with an amount of boron powder includes two steps. The first step is a gravimetric technique which includes extraction of the soluble residue on the boron powder and returns values reported in grams of extract per gram of boron. The second step of the test includes Fourier transform infrared spectroscopy which produces an infrared spectrum of light absorbed by the boron powder for a plurality of different wavelengths of light. This two-step test has been found to be repeatable.

The optimized boron powder can include crystalline boron particles created by jet milling a boron feed stock to a specified particle size. For example, more than about 75% of the particles are less than about 1 micron in diameter, more than about 95% of the particles are less than about 3 microns in diameter, and essentially all of the particles are less than about 15 microns in particle diameter. Optimal neutron detector performance depends in part upon a relatively thin coating of boron powder applied to the neutron detector surface. Ideally, neutrons entering the neutron detector are absorbed by the boron which then releases other charged particles that can cause a cascade of particle interactions which then interact with a cathode portion of the neutron detector. However, if the boron powder application is relatively thick, the boron will simply absorb the neutron without releasing other charged particles and become “self-trapping,” rendering the neutron detector ineffective. Therefore, it is desirable to obtain an optimized boron powder with particle sizes of about 1 micron in diameter to enable relatively thin coatings on the neutron detector surface.

The optimized boron powder can include further limitations on other chemical elements and chemical compounds. For example, the optimized boron powder can include a maximum Br content of about 100 parts per million, a maximum Co content of about 20 parts per million, a maximum Cu content of about 200 parts per million, a maximum Fe and Si content of about 4000 parts per million when measured together, a maximum Mn content of about 20 parts per million, a maximum Ni content of about 200 parts per million, a maximum Ta content of about 40 parts per million, a maximum Zn content of about 100 parts per million, a maximum C content of about 1.5% by weight, a maximum H₂O content of about 1.0% by weight, a maximum O₂ content of about 2.0% by weight, other constituents having a maximum content of about 50 parts per million (each), and a minimum B content of about 98% by weight. High Z elements (those with a high atomic number of protons in their nuclei) react with gamma radiation and can produce false signals in a neutron detector if significant quantities are present in the boron powder coating. Both H₂O and O₂, when present in the boron powder coating in significant quantities, can poison the gas that fills the interior volume of the neutron detector, stop the cascade of atomic particle interactions, and thereby reduce the effectiveness of the neutron detector. Thus, it is desirable to limit the amounts of these materials within the optimized boron powder.

The optimized boron powder can also include a specific ratio of the naturally occurring isotopes of boron. For example, the total boron content is a minimum of about 97% by weight and the ratio of ¹⁰B isotope to the total boron content is a minimum of about 98% by weight. Boron has two naturally occurring isotopes, ¹⁰B and ¹¹B, typically found in a ratio of about 20% ¹⁰B to about 80% ¹¹B. In average circumstances, the two isotopes react quite differently when interacting with a free neutron. Ideally, neutrons entering the neutron detector are absorbed by the ¹⁰B which then releases other charged particles that can cause a cascade of particle interactions which then interact with a cathode portion of the neutron detector. Typical neutron detectors rely on these released charged particles and the cascade of other resultant particle interactions to develop a signal representing a detected neutron or group of neutrons. However, the ¹¹B isotope simply absorbs the neutron without releasing other charged particles, making ¹¹B ineffective for use in an optimized boron powder for neutron detection applications. This difference in neutron absorption behavior between the two naturally occurring boron isotopes means that the ratio of ¹⁰B isotope to the total boron content is approximately equal to the effectiveness of the neutron detector. For example, if a boron coating contains 92% ¹⁰B and 8% ¹¹B, the neutron detector will be 92% effective (disregarding small quantities of impurities in the coating). Therefore, it is desirable to create a ratio of ¹⁰B isotope to the total boron content in the optimized boron powder that is as high as is practicably attainable.

The optimized boron powder can be applied to a neutron detector surface in a repeatable coating operation to achieve consistent detector effectiveness results. This effectiveness is a direct result of reduced soluble residue in the optimized boron powder which helps reduce neutron detector surface wetting inconsistencies and outgassing in the assembled neutron detector. One example of the boron powder application to a neutron detector surface is a water-based dispersion, however, the elimination of soluble residue may also improve coating techniques such as powder coating and solvent-based dispersions.

The neutron detector effectiveness is further a result of the uniform, small diameter of the crystalline boron powder particles which help enable relatively thin coatings on neutron detector surfaces. Additionally, the neutron detector effectiveness is a result of limited amounts of chemical elements and chemical compounds other than boron. The material specification helps limit the amount of material in the boron coating that will be affected by gamma radiation and helps limit the amount of oxygen that could be introduced into the neutron detector interior volume, thereby poisoning the gas, and reducing the neutron detector effectiveness. The neutron detector effectiveness is also a result of maximizing the ratio of ¹⁰B isotope to the total boron content in the optimized boron powder. The increased ratio of ¹⁰B isotope allows more material in the boron coating on the neutron detector surface that reacts to free neutrons as the coating is designed and not simply absorb free neutrons.

The described techniques and methods of obtaining an optimized boron powder for neutron detection applications help ensure repeatable boron powder coating operations and also help ensure consistent detector sensitivity. Moreover, the techniques and methods described also help ensure a reproducible operation jet milling boron powder.

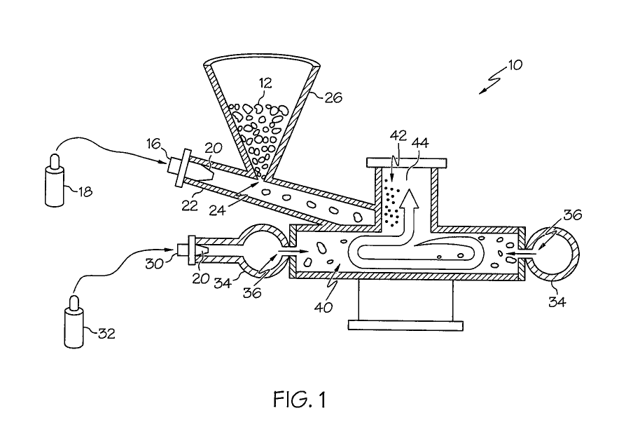

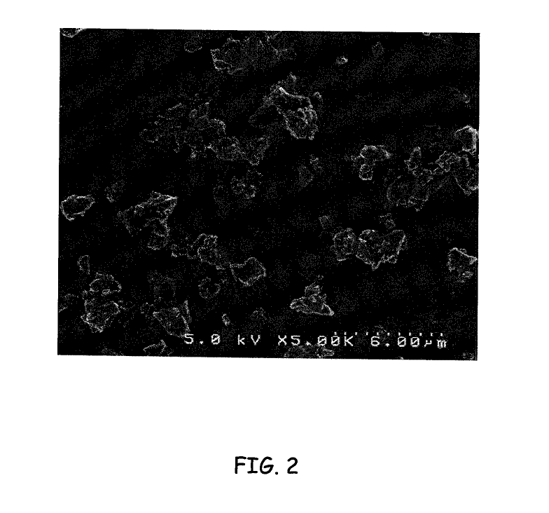

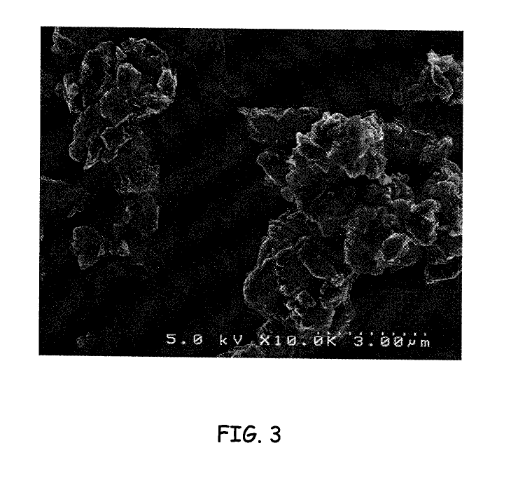

FIG. 1 is a scanning electron microscope photograph of an example optimized boron powder for neutron detection applications. The example boron powder is magnified 5,000 times. FIG. 2 is a scanning electron microscope photograph of an example optimized boron powder magnified 10,000 times. FIG. 3 is a scanning electron microscope photograph of an example optimized boron powder magnified 25,000 times.

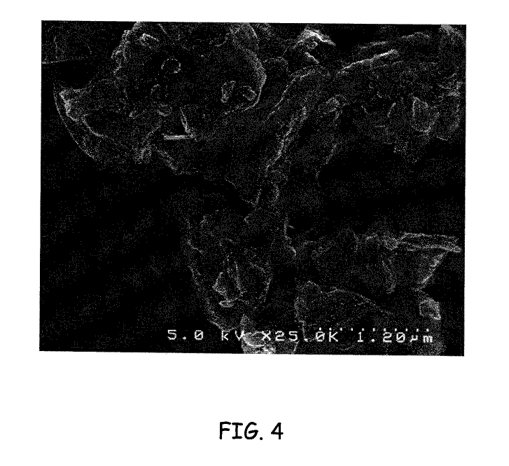

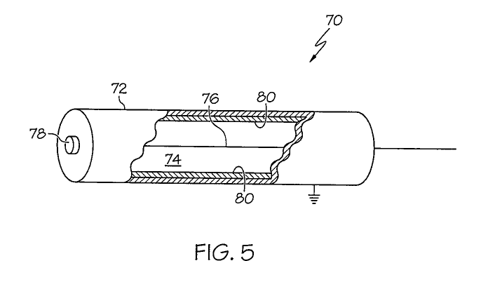

A schematic rendering of an example neutron detector 10 is generally shown within FIG. 4. It is to be appreciated that FIG. 4 shows one example of possible structures/configurations/etc. and that other examples are contemplated within the scope of the present invention. The neutron detector 10 can include an exterior shell 20 in the form of a cylinder. In an electrical circuit, the exterior shell 20 can act as a cathode. The exterior shell 20 bounds an interior volume 30 which can contain a gas. The neutron detector 10 can include a central structure 40 that can be generally located near the central axis of the exterior shell 20. The central structure 40 can be of similar proportions to a wire, and can act as an anode in an electrical circuit. An insulator 50 can be located on both ends of the exterior shell 20 to hold the central structure 40 in place and prevent electrical charges from passing between the central structure 40 and the exterior shell 20 by direct contact. The interior surface of the exterior shell 20 can be coated with an optimized boron powder forming a boron coating 60.

As neutrons from the environment surrounding the neutron detector 10 pass through the exterior shell 20 of the neutron detector 10, they interact with a relatively thin layer of boron coating 60. The neutron is absorbed into the boron coating 60 and the action forces two charged particles to be discharged from the boron coating 60. These two charged particles induce a cascade of other particle interactions within the gas occupying the interior volume 30. These other particle interactions create charged particles that are attracted to the central structure 40 anode. The charged particles can create a signal on the central structure 40 anode which can be transmitted to electronic equipment (not shown) that may include a preamp.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

1. A boron powder, wherein the quantity of a soluble residue comingled with the boron powder is less than 7.00×10⁻⁴ grams of soluble residue per gram of boron,
wherein the boron powder includes crystalline boron particles created by jet milling a boron feed stock wherein:
more than about 75% of the crystalline boron particles are less than about 1 micron in diameter;
more than about 95% of the crystalline boron particles are less than about 3 microns in diameter; and
essentially all of the crystalline boron particles are less than about 15 microns in diameter.

2. (canceled)

3. The boron powder according to claim 1, wherein the chemical composition of the boron powder includes:
a maximum Br content of about 100 parts per million;
a maximum Co content of about 20 parts per million;
a maximum Cu content of about 200 parts per million;
a maximum Fe and Si content of about 4000 parts per million when measured together;
a maximum Mn content of about 20 parts per million;
a maximum Ni content of about 200 parts per million;
a maximum Ta content of about 40 parts per million;
a maximum Zn content of about 100 parts per million;
a maximum C content of about 1.5% by weight;
a maximum H₂O content of about 1.0% by weight;
a maximum O₂ content of about 2.0% by weight;
other constituents having a maximum content of about 50 parts per million (each); and
a minimum B content of about 98% by weight.

4. The boron powder according to claim 1, wherein the total boron content is a minimum of about 97% by weight and the ratio of ¹⁰B isotope to the total boron content is a minimum of about 98% by weight.
